(19) United States
(12) Patent Application Publication
(10) Pub. No.: US 2006/0222074 A1
(43) Pub. Date: Oct. 5, 2006

(54) Method and system for motion estimation in a video encoder

(76) Inventor: Bo Zhang, Westford, MA (US)

Correspondence Address: MCANDREWS HELD & MALLOY, LTD, 500 WEST MADISON STREET, SUITE 3400, CHICAGO, IL, 60661, US

(21) Appl. No.: 11/096,476

(22) Filed: Apr. 1, 2005

(51) Int. Cl. H04N 11/02; H04N 11/04; H04N 7/12; H04B 1/66

(52) U.S. Cl. 375/240.16; 375/240.12; 375/240.24

(57) ABSTRACT

Described herein is a method and system for motion estimation in a video encoder. There are two parts to the motion estimation. Coarse motion estimation generates a set of motion vectors for a current picture and at two or more reference pictures. Fine motion estimation can refine coarse motion estimation results by searching interpolated video data in a region defined by the motion vectors from the coarse motion estimation. Prior to fine motion estimation, the set of motion vectors generated by coarse motion estimation are consolidated in a two level process. In the first level, all motion vectors associated with a particular reference picture are eliminated. For each remaining reference picture in the second level, individual motion vectors are eliminated based on a cost comparison of among motion vectors in a neighborhood.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Video communications systems are continually being enhanced to meet requirements such as reduced cost, reduced size, improved quality of service, and increased data rate. Many advanced processing techniques can be specified in a video compression standard. Typically, the design of a compliant video encoder is not specified in the standard. Optimization of the communication system's requirements is dependent on the design of the video encoder.

The video encoding standard H.264 utilizes a combination of intra-coding and inter-coding. Intra-coding uses spatial prediction based on information that is contained in the picture itself. Inter-coding uses motion estimation and motion compensation based on previously encoded pictures. The encoding process for motion estimation consists of selecting motion data comprising a motion vector that describes a displacement applied to samples of a previously encoded picture. As the number of ways to partition a picture increases, this selection process can become very complex, and optimization can be difficult given the constraints of some hardware.

Limitations and disadvantages of conventional and traditional approaches will become apparent to one of ordinary skill in the art through comparison of such systems with the present invention as set forth in the remainder of the present application with reference to the drawings.

### BRIEF SUMMARY OF THE INVENTION

Described herein are system(s) and method(s) for encoding video data, substantially as shown in and/or described in connection with at least one of the figures, as set forth more completely in the claims.

These and other advantages and novel features of the present invention will be more fully understood from the following description.

### BRIEF DESCRIPTION OF THE DRAWINGS

FIG. 1 is a block diagram of an exemplary picture in the H.264 coding standard in accordance with an embodiment of the present invention;

FIG. 2 is a block diagram describing spatially encoded macroblocks in accordance with an embodiment of the present invention;

FIG. 3 is a block diagram describing temporally encoded macroblocks in accordance with an embodiment of the present invention;

FIG. 4 is a block diagram of an exemplary video encoding system in accordance with an embodiment of the present invention;

FIG. 5 is a block diagram of an exemplary motion estimator in accordance with an embodiment of the present invention;

FIG. 6 is a block diagram of a current picture in accordance with an embodiment of the present invention;

FIG. 7 is a block diagram of a reference picture in accordance with an embodiment of the present invention;

FIG. 8 is a block diagram of macroblock and sub-macroblock partitions in accordance with an embodiment of the present invention;

FIG. 9 is a block diagram of a macroblock neighborhood in accordance with an embodiment of the present invention;

FIG. 10 is a block diagram of a refinement engine in accordance with an embodiment of the present invention; and

FIG. 11 is a flow diagram of an exemplary method for motion estimation in accordance with an embodiment of the present invention.

### DETAILED DESCRIPTION OF THE INVENTION

According to certain aspects of the present invention, a system and method for motion estimation in a video encoder are presented. The invention can be applied to video data encoded with a wide variety of standards, one of which is H.264. An overview of H.264 will now be given. A description of an exemplary system for motion estimation in H.264 will also be given.

H.264 Video Coding Standard

The ITU-T Video Coding Experts Group (VCEG) and the ISO/IEC Moving Picture Experts Group (MPEG) drafted a video coding standard titled ITU-T Recommendation H.264 and ISO/IEC MPEG-4 Advanced Video Coding, which is incorporated herein by reference for all purposes. In the H.264 standard, video is encoded on a macroblock-by-macroblock basis. The generic term “picture” refers to frames and fields.

The specific algorithms used for video encoding and compression form a video-coding layer (VCL), and the protocol for transmitting the VCL is called the Network Access Layer (NAL). The H.264 standard allows a clean interface between the signal processing technology of the VCL and the transport-oriented mechanisms of the NAL, so source-based encoding is unnecessary in networks that may employ multiple standards.

By using the H.264 compression standard, video can be compressed while preserving image quality through a combination of spatial, temporal, and spectral compression techniques. To achieve a given Quality of Service (QoS) within a small data bandwidth, video compression systems exploit the redundancies in video sources to de-correlate spatial, temporal, and spectral sample dependencies. Statistical redundancies that remain embedded in the video stream are distinguished through higher order correlations via entropy coders. Advanced entropy coders can take advantage of context modeling to adapt to changes in the source and achieve better compaction.

An H.264 encoder can generate three types of coded pictures: Intra-coded (I), Predictive (P), and Bi-directional (B) pictures. An I picture is encoded independently of other pictures based on a transformation, quantization, and entropy coding. I pictures are referenced during the encoding of other picture types and are coded with the least amount of compression. P picture coding includes motion compensation with respect to another picture. A B picture is an interpolated picture that uses two reference pictures. The picture type I uses the exploitation of spatial redundancies while types P and B use exploitations of both spatial and temporal redundancies. Typically, I pictures require more bits than P pictures, and P pictures require more bits than B pictures.

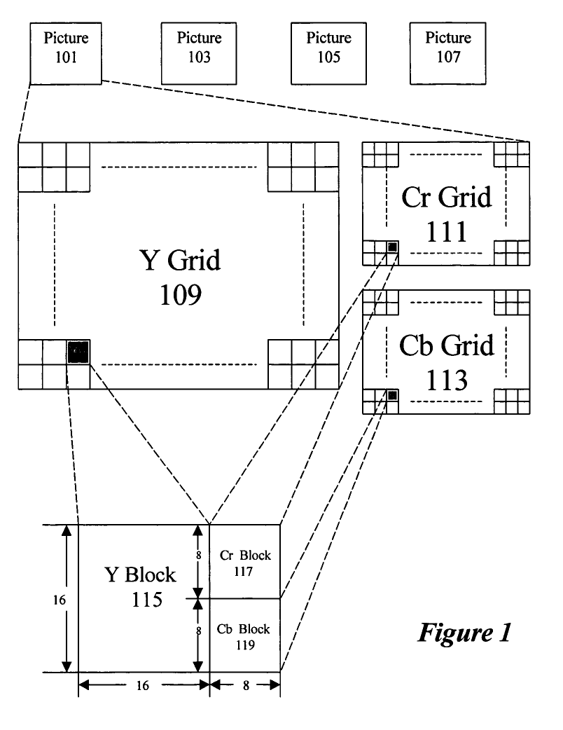

In FIG. 1 there is illustrated a block diagram of an exemplary picture 101. The picture 101 along with successive pictures 103, 105, and 107 form a video sequence. The picture 101 comprises two-dimensional grid(s) of pixels. For color video, each color component is associated with a unique two-dimensional grid of pixels. For example, a picture can include luma, chroma red, and chroma blue components. Accordingly, these components are associated with a luma grid 109, a chroma red grid 111, and a chroma blue grid 113. When the grids 109, 111, 113 are overlaid on a display device, the result is a picture of the field of view at the duration that the picture was captured.

Generally, the human eye is more perceptive to the luma characteristics of video, compared to the chroma red and chroma blue characteristics. Accordingly, there are more pixels in the luma grid 109 compared to the chroma red grid 111 and the chroma blue grid 113. In the H.264 standard, the chroma red grid 111 and the chroma blue grid 113 have half as many pixels as the luma grid 109 in each direction. Therefore, the chroma red grid 111 and the chroma blue grid 113 each have one quarter as many total pixels as the luma grid 109.

The luma grid 109 can be divided into 16×16 pixel blocks. For a luma block 115, there is a corresponding 8×8 chroma red block 117 in the chroma red grid 111 and a corresponding 8×8 chroma blue block 119 in the chroma blue grid 113. Blocks 115, 117, and 119 are collectively known as a macroblock that can be part of a slice group. Currently, sub-sampling is the only color space used in the H.264 specification. This means, a macroblock consist of a 16×16 luminance block 115 and two (sub-sampled) 8×8 chrominance blocks 117 and 118.

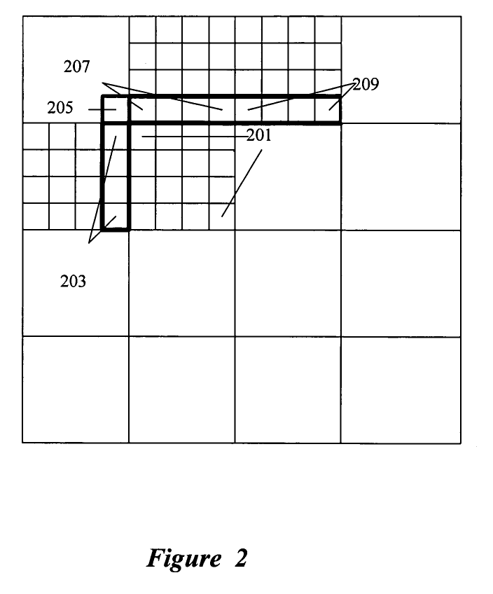

Referring now to FIG. 2, there is illustrated a block diagram describing spatially encoded macroblocks. Spatial prediction, also referred to as intra-prediction, involves prediction of picture pixels from neighboring pixels. The pixels of a macroblock can be predicted, in a 16×16 mode, an 8×8 mode, or a 4×4 mode. A macroblock is encoded as the combination of the prediction errors representing its partitions.

In the 4×4 mode, a macroblock 201 is divided into 4×4 partitions. The 4×4 partitions of the macroblock 201 are predicted from a combination of left edge partitions 203, a corner partition 205, top edge partitions 207, and top right partitions 209. The difference between the macroblock 201 and prediction pixels in the partitions 203, 205, 207, and 209 is known as the prediction error. The prediction error is encoded along with an identification of the prediction pixels and prediction mode.

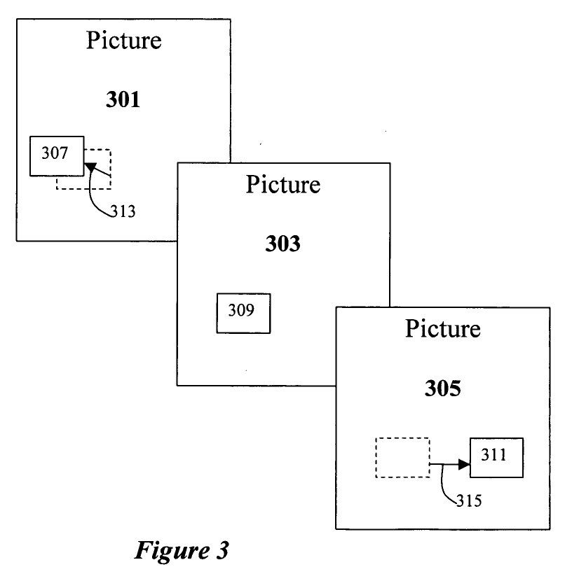

Referring now to FIG. 3, there is illustrated a block diagram describing temporally encoded macroblocks. In bi-directional coding, a current partition 309 in the current picture 303 is predicted from a reference partition 307 in a previous picture 301 and a reference partition 311 in a later arriving picture 305. Accordingly, a prediction error is calculated as the difference between the weighted average of the reference partitions 307 and 311 and the current partition 309. The prediction error and an identification of the prediction partitions are encoded. Motion vectors 313 and 315 identify the prediction partitions.

The weights can also be encoded explicitly, or implied from an identification of the picture containing the prediction partitions. The weights can be implied from the distance between the pictures containing the prediction partitions and the picture containing the partition.

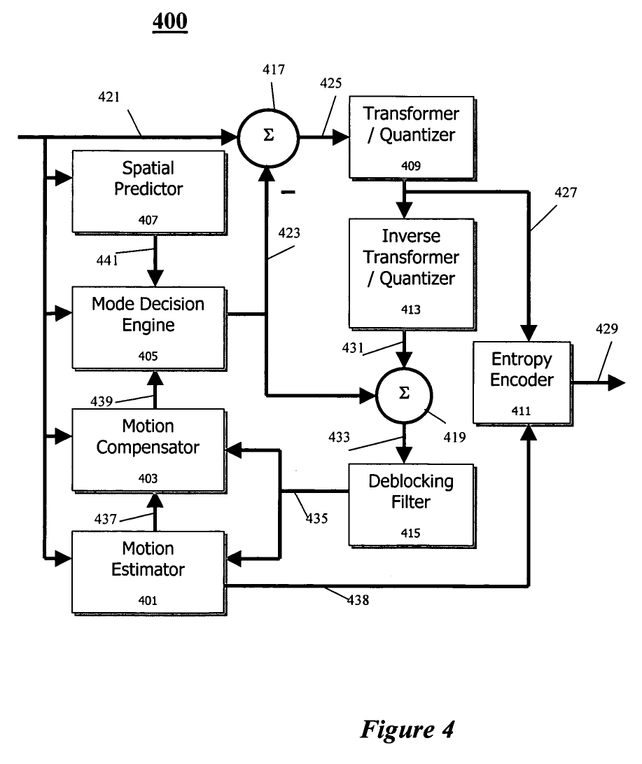

Referring now to FIG. 4, there is illustrated a block diagram of an exemplary video encoder 400. The video encoder 400 comprises a motion estimator 401, a motion compensator 403, a mode decision engine 405, spatial predictor 407, a transformer/quantizer 409, an entropy encoder 411, an inverse transformer/quantizer 413, and a deblocking filter 415.

The spatial predictor 407 uses only the contents of a current picture 421 for prediction. The spatial predictor 407 receives the current picture 421 and produces a spatial prediction 441 corresponding to reference blocks as described in reference to FIG. 2.

Spatially predicted pictures are intra-coded. Luma macroblocks can be divided into 4×4 blocks or 16×16 blocks. There are 9 prediction modes available for 4×4 macroblocks and 4 prediction modes available for 16×16 macroblocks. Chroma macroblocks are 8×8 blocks and have 4 possible prediction modes.

In the motion estimator 401, the current picture 421 is estimated from reference blocks 435 using a set of motion vectors 437. The motion estimator 401 receives the current picture 421 and a set of reference blocks 435 for prediction. A temporally encoded macroblock can be divided into 16×8, 8×16, 8×8, 4×8, 8×4, or 4×4 blocks. Each block of a macroblock is compared to one or more prediction blocks in another picture(s) that may be temporally located before or after the current picture. Motion vectors describe the spatial displacement between blocks and identify the prediction block(s).

The motion compensator 403 receives the motion vectors 437 and the current picture 421 and generates a temporal prediction 439. Interpolation can be used to increase accuracy of motion compensation to a quarter of a sample distance. The prediction values at half-sample positions can be obtained by applying a 6-tap FIR filter or a bi-linear interpolator, and prediction values at quarter-sample positions can be generated by averaging samples at the integer- and half-sample positions. The prediction values for the chroma components are typically obtained by bi-linear interpolation. In cases where the motion vector points to an integer-sample position, no interpolation is required. Motion compensation runs along with the main encoding loop to allow intra-prediction macroblock pipelining.

The mode decision engine 405 will receive the spatial prediction 441 and temporal prediction 439 and select the prediction mode according to a sum of absolute transformed difference (SATD) cost that optimizes rate and distortion. A selected prediction 423 is output.

Once the mode is selected, a corresponding prediction error 425 is the difference 417 between the current picture 421 and the selected prediction 423. The transformer/quantizer 409 transforms the prediction error and produces quantized transform coefficients 427. In H.264, there are 52 quantization levels.

Transformation in H.264 utilizes Adaptive Block-size Transforms (ABT). The block size used for transform coding of the prediction error 425 corresponds to the block size used for prediction. The prediction error is transformed independently of the block mode by means of a low-complexity 4×4 matrix that together with an appropriate scaling in the quantization stage approximates the 4×4 Discrete Cosine Transform (DCT). The Transform is applied in both horizontal and vertical directions. When a macroblock is encoded as intra 16×16, the DC coefficients of all 16 4×4 blocks are further transformed with a 4×4 Hardamard Transform.

H.264 specifies two types of entropy coding: Context-based Adaptive Binary Arithmetic Coding (CABAC) and Context-based Adaptive Variable-Length Coding (CAVLC). The entropy encoder 411 receives the quantized transform coefficients 427 and produces a video output 429. In the case of temporal prediction, a set of picture reference indices 438 are entropy encoded as well.

The quantized transform coefficients 427 are also fed into an inverse transformer/quantizer 413 to produce a regenerated error 431. The original prediction 423 and the regenerated error 431 are summed 419 to regenerate a reference picture 433 that is passed through the deblocking filter 415 and used for motion estimation.

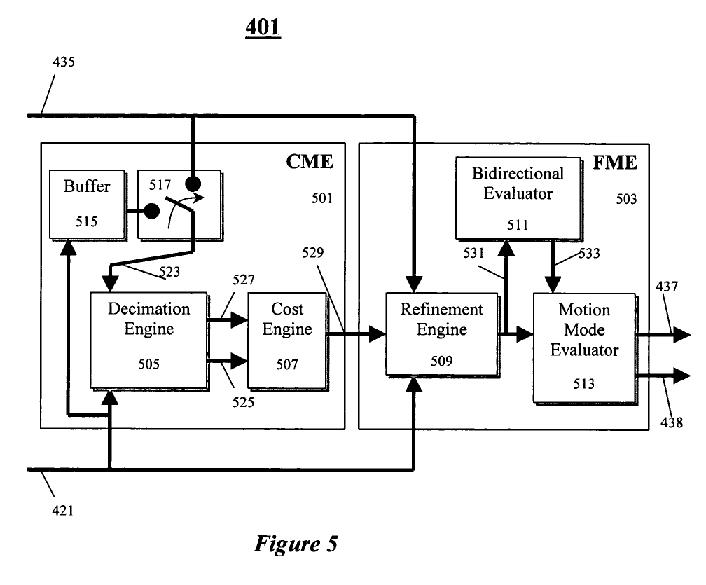

Referring now to FIG. 5, a block diagram of an exemplary motion estimator 401 is shown. The motion estimator 401 comprises a coarse motion estimator 501 and a fine motion estimator 503.

Coarse Motion Estimator (CME) 501

The coarse motion estimator 501 comprises a decimation engine 505 and a costing engine 507 and may also comprise a buffer 513 and a selector 515. The coarse motion estimator 501 can run ahead of other blocks in the video encoder. For example, the coarse motion estimator 501 can process at least one macroblock row before the fine motion estimator 503.

The coarse motion estimator 501 can select 517 a reference picture 523 to be a reconstructed picture 435 or an original picture 421 that has been buffered 515. By using an original picture 421 as the reference picture 523, the coarse motion estimator 501 yields “true” motion vectors 529 as candidates for the fine motion estimator 503 and allows picture level pipelining.

The decimation engine 505 receives the current (original) picture 421 and one or more reference pictures 523. The decimation engine 505 produces a sub-sampled current picture 525 and one or more sub-sampled reference pictures 527. Sub-sampling can reduce the occurrence of spurious motion vectors that arise from an exhaustive search of small block sizes. The decimation engine 505 can sub-sample frames using a 2×2 pixel average. Typically, the coarse motion estimator 501 operates on macroblocks of size 16×16. After sub-sampling, the size is 8×8 for the luma grid and 4×4 for the chroma grids. Fields of size 16×8 can be sub-sampled in the horizontal direction, so a 16×8 field partition could be evaluated as size 8×8.

The coarse motion estimator 501 search can be exhaustive. The costing engine 507 determines a cost for motion vectors that describe the displacement from a section of a sub-sampled reference picture 527 to a macroblock in the sub-sampled current picture 525. The cost can be based on a sum of absolute difference (SAD). The output 529 of the costing engine 507 is one motion vector for every reference picture and macroblock combination. The selection is based on cost.

Fine Motion Estimator (FME) 503

The fine motion estimator 503 comprises a refinement engine 509, a bidirectional evaluator 511, and a motion mode evaluator 513. The fine motion estimator 503 can be non-causal, and can have a macroblock level pipeline that runs slightly ahead of (e.g. one or more macroblocks) the main encoding loop. CME results 529 from macroblocks that follow after a current macroblocks can be used in FME.

The refinement engine 509 can search all partitions. The refinement engine 509 can take advantage of various small partition sizes with a multiple candidate approach. Breaking causality helps a motion vector search for smaller partition sizes along moving edges. Macroblock level pipelining allows motion compensation and fine motion estimation to run independently.

The refinement engine 509 receives the current picture 421, reconstructed reference pictures 435, and motion vectors 529 from the CME. The motion vectors 529 that are based on sub-sampled macro-blocks can be described in terms of picture element (pel) resolution. Using 2×2 pixel averages may result in single or double pel resolution.

For each reference picture 435, refinement can be performed for macroblock partitions and sub-macroblocks partitions. For a refinement search of a partition in a macroblock, the refinement engine 509 can use, as candidates, the motion vectors 529 of the macroblock and up to eight neighboring macroblocks. The output 531 of the refinement engine 509 can be one or more motion vectors and the associated costs. Finer resolution can be achieved by interpolating partitions. Candidate elimination can be based on a cost for prediction that that results from displacing a portion of the reference picture according to the motion vector. Candidate elimination can also be based on CME results, FME results of previous macroblocks, and temporal distance between a macroblock and a reference section. An entire reference picture may be eliminated or candidates for each reference picture may be eliminated individually.

A difference between B and P pictures is that B pictures may be predicted by a weighted average of two motion-compensated prediction values. For each reference picture pair, the bidirectional evaluator 511 uses uni-directional motion vectors 531 decided in the refinement step. A motion vector set and an associated cost 533 for the prediction is output.

The motion mode evaluator 513 makes estimation mode decisions and outputs data that includes the motion vectors 437 and associated reference indices 438 for each macroblock, macroblock partition and sub-macroblock partition. Uni-directional or bi-directional modes can also be indicated.

The motion mode evaluator 513 can make mode decisions in the following order: 1) sub-macroblock partition mode for each reference picture, 2) uni-directional prediction among all reference pictures, 3) bi-direction prediction among all reference picture pairs, 4) overall prediction between uni-direction and bi-direction predictions, and 5) macroblock partition mode.

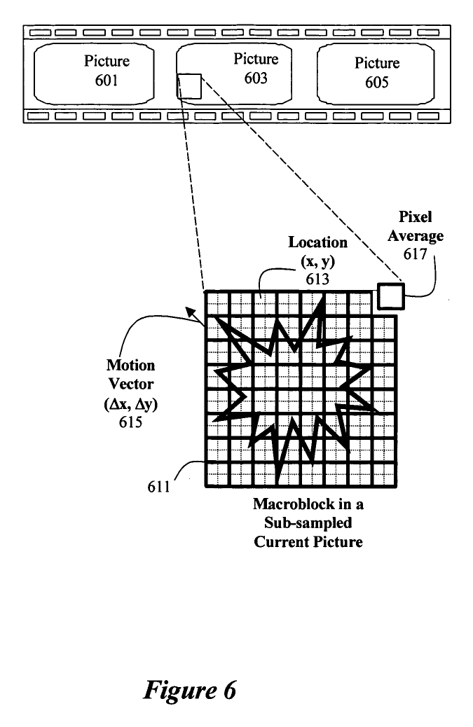

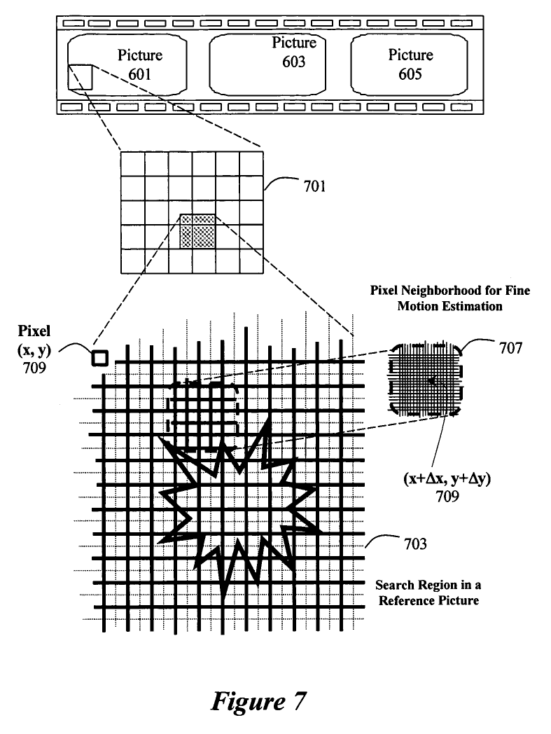

Refer now to FIG. 6 and FIG. 7. FIG. 6 is a block diagram of a current picture, and FIG. 7 is a block diagram of a reference picture. Three pictures 601, 603, and 605 are shown. The reference picture is at 601 and the current picture is at 603. A coarse motion estimator decimates a portion 611 of the current picture 603 and a reference region 703 in the reference picture 601. An element of the sub-sampled portion 611 is a pixel average 617. A cost engine evaluates a correlation between the sub-sampled portion 611 and the reference region 703. A motion vector (Δx, Δy) 615 represents the displacement from the sub-sampled portion 611. A location (x, y) 613 corresponds to a location (x+Δx, y+Δy) 709 in the reference region 703. To determine a cost for motion vector (Δx, Δy) 615, location (x, y) 613 is compared to location (x+Δx, y+Δy) 709.

To determine a cost during fine motion estimation, a picture is interpolated (e.g. to quarter pel resolution). The motion vector (Δx, Δy) 615 that was derived in coarse motion estimation, associates location (x, y) 613 with an interpolated neighborhood of pixels 707 around location (x+Δx, y+Δy) 709. When cost is computed for macroblock and sub-macroblock partitions, reference portions in the reference region 703 can correspond to motion vector (Δx, Δy) 615 and motion vectors (n+Δx, m+Δy) where m and n can vary, for example, from −2 to +2 pels with quarter pel resolution. Cost may also be determined by a set of pixels in the reference picture with coordinates corresponding to the current picture. No displacement is referred to as motion vector zero.

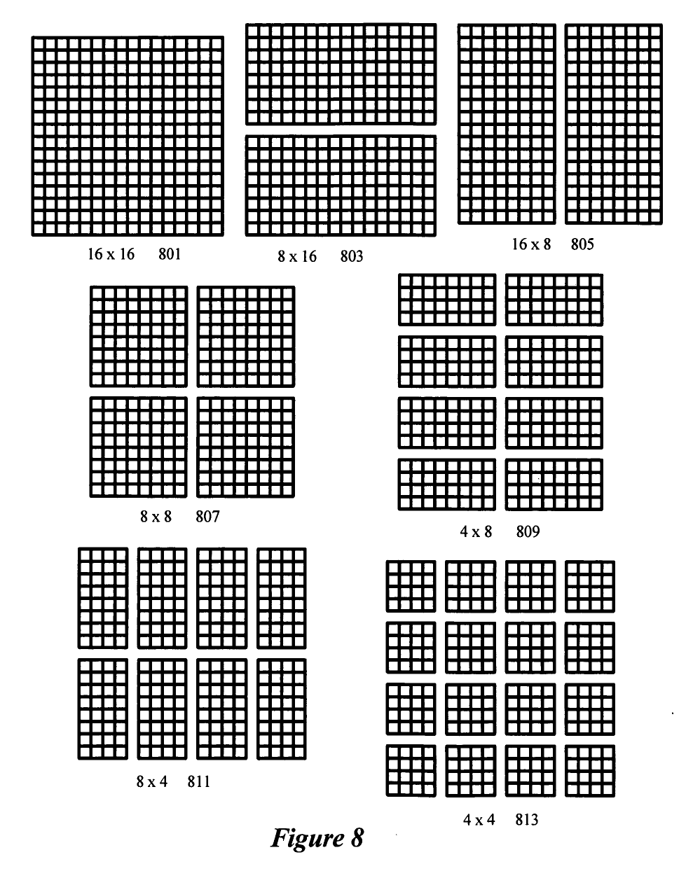

FIG. 8 is a block diagram of macroblock and sub-macroblock partitions in accordance with an embodiment of the present invention. Macroblock partitions include: 1 of size 16×16 at 801, 2 of size 8×16 at 803, and 2 of size 16×8 at 805. Sub-macroblock partitions include: 4 of size 8×8 at 807, 8 of size 4×8 at 809, 8 of size 8×4 at 811, and 16 of size 4×4 at 813.

A H.264 video encoder could take advantage of many reference pictures, and each one of the reference pictures could have multiple motion vectors. These motion vectors are candidates that may be selected to form a search region for FME. The CME produces a motion vector for every reference picture and macroblock pair. Processing all of the motion vectors may be prohibitive. The number of motion vectors that can be processed may be limited to fit hardware and latency requirements.

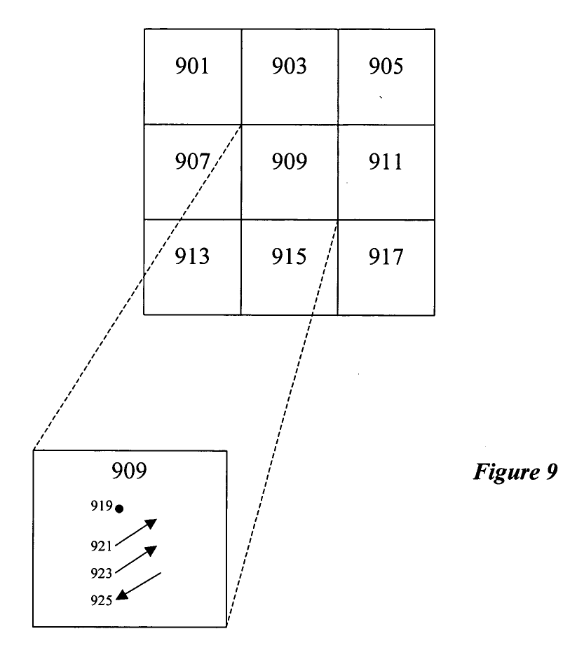

Referring now to FIG. 9, a current macroblock 909 and neighboring macroblocks 901, 903, 905, 907, 911, 913, 915, and 917 are shown. The fine motion estimator will search a range in a reference picture defined by motion vectors. Each macroblock has a set of associated motion vectors. H.264 does not limit the number of reference picture that can be used. For an illustrative example, the current macroblock 909 is shown with motion vectors 921, 923, and 925 that are associated with reference indices in three reference pictures. Likewise, the neighboring macroblocks 901, 903, 905, 907, 911, 913, 915, and 917 also would also have three associated motion vectors.

To support variable design constraints, a two-level motion vector selection may be utilized. In the first level, all motion vectors associated with a particular reference picture are eliminated. The elimination is based on a cost of a reference picture with respect to the current macroblock 909 and other macroblocks 901, 903, 905, 907, 911, 913, 915, and 917 around it. Cost is generally a metric that indicates the amount of information required for encoding. The cost may also include a bias for temporal distance. The temporal distance can be based on a reference index and a number of bits used to code the reference picture. By computing the cost, a motion estimation result that uses the reference picture can be evaluated in advance.

A first part of a cost can be the sum of absolute difference (SAD) for the reference picture with respect to the current macroblock 909. The bits of the reference picture multiplied by the reference index number can be a second part the cost. A third part of the cost can be an average of the SAD for the reference picture with respect to the macroblocks 901, 903, 905, 907, 911, 913, 915, and 917 surrounding the current macroblock 909. When taking the average, a motion vector associated with a macroblock 903, 907, 911, or 915 that shares an edge with the current macroblock 909 can be given a greater weighting. The three parts of the cost can be weighted independently as well. For example, the second and third part can be scaled down with respect to the first part, thereby giving a higher priority to the SAD with respect to the current macroblock 909.

Reference pictures that remain after level one elimination can be called candidate reference pictures. In level two candidate elimination, motion vector reduction can begin for the candidates associated with the candidate reference pictures. For each macroblock and reference picture, ten motion vector candidates could be used to form the search region. The first motion vector can be a zero vector 919. The zero vector 919 maps to the portion of the reference picture having the same coordinates as the current macroblock 909. The remaining nine motion vectors can come from the macroblock neighborhood 901, 903, 905, 907, 909, 911, 913, 915, and 917. A cost comparison can be used in level two candidate elimination. The cost can be similar to the first part of level one candidate elimination. The SAD for the motion vectors associated with each macroblock 901, 903, 905, 907, 909, 911, 913, 915, and 917 can be computed. The cost can then be biased to favor one candidate motion vector over another. A motion vector associated with a macroblock 903, 907, 911, or 915 that shares an edge with the current macroblock 909 may be more favorable than a motion vector associated with a macroblock 901, 905, 913, or 917 that shares only a corner with the current macroblock 909.

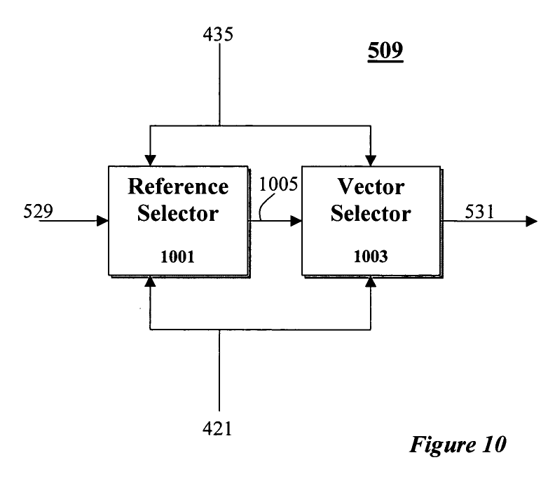

Referring now to FIG. 10, a block diagram of a refinement engine 509 is shown. The refinement engine 509 comprises a reference selector 1001 and a vector selector 1003. In the reference selector 1001, all motion vectors 529 associated with a particular reference picture in the set of reference pictures 435 are eliminated. The elimination is based on a cost of a reference picture 435 with respect to a current picture 421, more specifically the current macroblock and other macroblocks in the neighborhood around it. The cost may also include a bias for temporal distance. The temporal distance can be based on a reference index and a number of bits used to code the reference picture 435. By computing the cost, a motion estimation result that uses the reference picture can be evaluated in advance.

A first part of a cost can be the sum of absolute difference (SAD) for the reference picture 435 with respect to the current macroblock of the current picture 421. The bits of the reference picture multiplied by the reference index number can be a second part the cost. A third part of the cost can be an average of the SAD for the reference picture 435 with respect to the macroblocks and surrounding the current macroblock of the current picture 421. When taking the average, a motion vector associated with a macroblock that shares an edge with the current macroblock can be given a greater weighting. The three parts of the cost can be weighted independently as well. For example, the second and third part can be scaled down with respect to the first part, thereby giving a higher priority to the SAD with respect to the current macroblock.

Reference pictures that remain after level one elimination can be called candidate reference pictures. The motion vectors 1005 associated with the candidate reference pictures are passed to the vector selector 1003. In he vector selector 1003, motion vector reduction (or refinement) can begin for the candidate motion vectors 1005 associated with the candidate reference pictures 435. For each macroblock f the current picture 421 and reference picture 435, ten motion vector candidates 1005 could be used to form the search region. The first motion vector can be a zero vector that maps to the portion of the reference picture 435 having the same coordinates as the current macroblock. The remaining nine motion vectors can come from the macroblock neighborhood. A cost comparison can be used in vector selector 1003 that is based on the SAD for the motion vectors 1005 associated with each macroblock. The cost can then be biased to favor one candidate motion vector over another. A motion vector associated with a macroblock that shares an edge with the current macroblock may be more favorable than a motion vector associated with a macroblock that shares only a corner with the current macroblock. Accordingly, the cost bias is smaller for adjacent macroblocks.

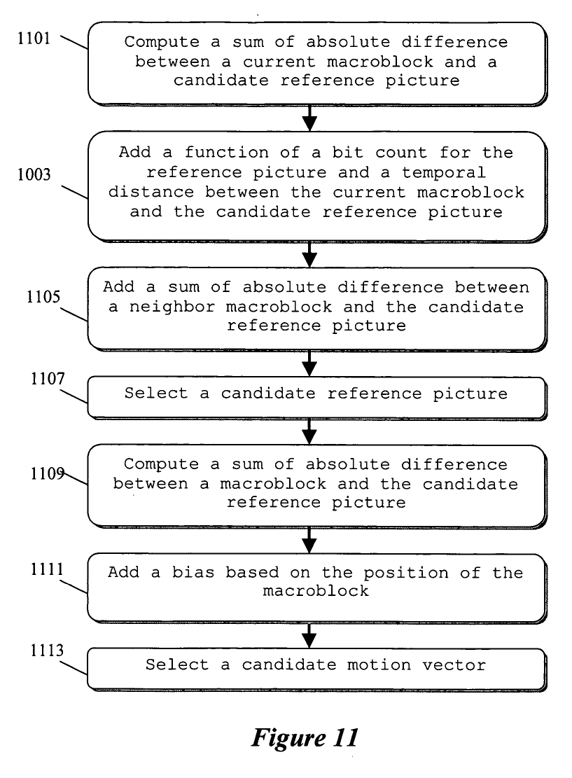

FIG. 11 is a flow diagram of an exemplary method for motion estimation in accordance with an embodiment of the present invention. Compute a sum of absolute difference between a current macroblock and a candidate reference picture at 1101. In H.264 the number of reference pictures is not limited, bur hardware constraints may create a design limitation for an actual number of reference pictures that can be utilized for motion estimation.

Add a function of a bit count for the reference picture and a temporal distance between the current macroblock and the candidate reference picture at 1103. This term may be scaled inhalation to the SAD value. Temporal distance will increase the cost for reference pictures that are further away from the current picture. Temporal distance will also increase the cost for reference pictures that require a high number of bits during the encoding process.

Add a sum of absolute difference between a neighbor macroblock and the candidate reference picture at 1105. Motion vectors associated with macroblocks that are spatially close to the current macroblock are used to define a search range. If the motion vector associated with current macroblock were spurious, the other motion vectors would keep the search region from being completely erroneous.

Select a candidate reference picture at 1107. All motion vectors associated with a reference picture that was not selected will be eliminated.

After the set of reference pictures are refined, individual motion vectors for the candidate reference picture are evaluated. Compute a sum of absolute difference between a macroblock and the candidate reference picture at 1109. The candidate motion vector represents a displacement between the macroblock and the candidate reference picture.

Add a bias based on the position of the macroblock at 1111, and select a candidate motion vector at 1113. The bias increases the second cost if the macroblock shares and edge with the current macroblock.

The embodiments described herein may be implemented as a board level product, as a single chip, application specific integrated circuit (ASIC), or with varying levels of a video classification circuit integrated with other portions of the system as separate components. An integrated circuit may store a supplemental unit in memory and use an arithmetic logic to encode, detect, and format the video output.

The degree of integration of the video classification circuit will primarily be determined by the speed and cost considerations. Because of the sophisticated nature of modern processors, it is possible to utilize a commercially available processor, which may be implemented external to an ASIC implementation.

If the processor is available as an ASIC core or logic block, then the commercially available processor can be implemented as part of an ASIC device wherein certain functions can be implemented in firmware as instructions stored in a memory. Alternatively, the functions can be implemented as hardware accelerator units controlled by the processor.

While the present invention has been described with reference to certain embodiments, it will be understood by those skilled in the art that various changes may be made and equivalents may be substituted without departing from the scope of the present invention.

Additionally, many modifications may be made to adapt a particular situation or material to the teachings of the present invention without departing from its scope. For example, although the invention has been described with a particular emphasis on MPEG-1 encoded video data, the invention can be applied to a video data encoded with a wide variety of standards.

Therefore, it is intended that the present invention not be limited to the particular embodiment disclosed, but that the present invention will include all embodiments falling within the scope of the appended claims.

1. A method for motion estimation in a video encoder, said method comprising:
selecting a candidate reference picture from a set of reference pictures; and
selecting a candidate motion vector from a set of motion vectors associated with the candidate reference picture.

2. The method of claim 1, wherein selecting the candidate reference pictures is based on a first cost.

3. The method of claim 2, wherein the first cost comprises a sum of absolute difference between a current macroblock and the candidate reference picture.

4. The method of claim 3, wherein the first cost further comprises a function of a temporal distance between the current macroblock and the candidate reference picture.

5. The method of claim 3, wherein the first cost further comprises a function of a bit count for the reference picture.

6. The method of claim 3, wherein the first cost comprises a sum of absolute difference between a neighbor macroblock and the candidate reference picture.

7. The method of claim 1, wherein selecting the candidate motion vector is based on a second cost.

8. The method of claim 7, wherein the second cost comprises a sum of absolute difference between a macroblock and the candidate reference picture, wherein the candidate motion vector represents a displacement between the macroblock and the candidate reference picture.

9. The method of claim 8, wherein the second cost further comprises a bias, wherein the bias is based on the position of the macroblock and a current macroblock.

10. The method of claim 9, wherein the bias increases the second cost if the macroblock shares an edge with the current macroblock.

11. A system for motion estimation in a video encoder, said system comprising:
a reference selector for selecting a candidate reference picture from a set of reference pictures; and
a vector selector for selecting a candidate motion vector from a set of motion vectors associated with the candidate reference picture.

12. The system of claim 11, wherein the reference selector generates a first cost.

13. The system of claim 12, wherein the first cost comprises a sum of absolute difference between a current macroblock and the candidate reference picture.

14. The system of claim 13, wherein the first cost further comprises a function of a temporal distance between the current macroblock and the candidate reference picture.

15. The system of claim 13, wherein the first cost further comprises a function of a bit count for the reference picture.

16. The system of claim 13, wherein the first cost comprises a sum of absolute difference between a neighbor macroblock and the candidate reference picture.

17. The system of claim 11, wherein the vector selector generates a second cost.

18. The system of claim 17, wherein the second cost comprises a sum of absolute difference between a macroblock and the candidate reference picture, wherein the candidate motion vector represents a displacement between the macroblock and the candidate reference picture.

19. The system of claim 18, wherein the second cost further comprises a bias, wherein the bias is based on the position of the macroblock and a current macroblock.

20. The system of claim 19, wherein the bias increases the second cost if the macroblock shares and edge with the current macroblock.
